(19) United States
(12) Patent Application Publication
(10) Pub. No.: US 2017/0047603 A1
(43) Pub. Date: Feb. 16, 2017

(54) METHOD OF CONTROLLING FUEL CELL SYSTEM, METHOD OF CONTROLLING FUEL CELL AUTOMOBILE, AND FUEL CELL AUTOMOBILE

(71) Applicant: HONDA MOTOR CO., LTD., Tokyo (JP)

(72) Inventor: Shuichi KAZUNO, Wako-shi (JP)

(21) Appl. No.: 15/230,973

(22) Filed: Aug. 8, 2016

(30) Foreign Application Priority Data
Aug. 10, 2015 (JP) 2015-158275

(51) Int. Cl. H01M 8/04828; B60L 11/18

(52) U.S. Cl. CPC H01M 8/04873; B60L 11/1883; H01M 2250/20

(57) ABSTRACT

A method of controlling a fuel cell system, a method of controlling a fuel cell automobile, and a fuel cell automobile are provided. When the SOC of a battery gets closer to an upper limit, there is a risk that overcharging of the battery may occur. In this case, using a BAT converter, inverter terminal voltage is stepped up to FC open circuit voltage or higher, whereby a step-up type FC converter is placed in an interruption state.

### CROSS-REFERENCE TO RELATED APPLICATION

This application is based upon and claims the benefit of priority from Japanese Patent Application No. 2015-158275 filed on Aug. 10, 2015, the contents of which are incorporated herein by reference.

### BACKGROUND OF THE INVENTION

Field of the Invention

The present invention relates to a method of controlling a fuel cell system for driving a load using power sources (fuel cell and electrical storage device) provided in parallel, and a method of controlling a fuel cell automobile in a case where the load is a traction motor, and a fuel cell vehicle for carrying out the above control methods.

Description of the Related Art

In a fuel cell automobile disclosed in Japanese Laid-Open Patent Publication No. 2011-205735 (hereinafter referred to as JP2011-205735A), the fuel cell voltage is stepped up by a fuel cell converter and the electrical storage device voltage is stepped up by an electrical storage device converter. These voltages are synthesized to produce synthesized electrical power, and the synthesized electrical power is used for driving a vehicle motor through an inverter (paragraphs [0019] and [0020] of JP2011-205735A).

According to paragraph [0031] of JP2011-205735A, operation of the fuel cell converter is stopped at the time of immediately stopping the vehicle motor, and the fuel cell and the inverter are electrically connected directly to each other (This state will be referred to as a “direct connection state.”). Further, according to the disclosure, in this direct connection state, normally, the inverter terminal voltage becomes significantly higher than the open circuit voltage (OCV) of the fuel cell. Therefore, power generation of the fuel cell is not performed, and thus, surplus electrical power generated by power generation is not supplied to the electrical storage device through the electrical storage device converter. Consequently, adverse effects on the electrical storage device converter or the inverter can be reduced.

### SUMMARY OF THE INVENTION

However, the OCV of the fuel cell is not constant, and changes depending on the degree of degradation of the fuel cell, and the temperature. Therefore, it has been found that, even in the case where the fuel cell and the inverter are placed in the direct connection state, the inverter terminal voltage may not be increased to the OCV of the fuel cell.

For example, as is known in the art, when the ambient temperature becomes low such as a temperature below the freezing point, in the solid polymer electrolyte fuel cell, so called PEM type fuel cell, the moisture of the electrolyte membrane is decreased by scavenging, and the OCV is increased.

In a case where the inverter terminal voltage is not increased to the OCV of the fuel cell, in the direct connection state, the fuel cell voltage gets closer to the inverter terminal voltage, and consequently, it may not possible to interrupt electrical power of the fuel cell.

In this case, since the surplus electrical power of the fuel cell is supplied to the electrical storage device through the electrical storage device converter, the electrical storage device converter may be affected adversely, and degradation of the electrical storage device due to overcharging thereof may be caused disadvantageously.

According to the paragraph [0032] of JP2011-205735A, in a state where the motor is stopped suddenly, if the inverter terminal voltage is lower than the OCV of the fuel cell, it is also possible to perform such a control that a command value for setting the inverter terminal voltage is changed to a value above the OCV.

However, the surplus electrical power of the fuel cell may cause overcharging of the electrical storage device regardless of whether the motor is stopped suddenly. JP2011-205735A does not include any suggestion about such a problem, or does not include any disclosure about means for solving the problem.

The present invention has been made to solve the problem of this type, and an object of the present invention is to provide a method of controlling a fuel cell system, a method of controlling a fuel cell automobile, and the fuel cell automobile, in which it is possible to prevent overcharging, etc. of an electrical storage device by surplus electrical power generated by a fuel cell.

According to an aspect of the present invention, a method of controlling a fuel cell system is provided. The fuel cell system includes a fuel cell configured to generate fuel cell voltage as a primary voltage, an electrical storage device configured to generate electrical storage device voltage as another primary voltage, a load drive unit to which a secondary voltage is supplied, the load drive unit being configured to drive a load, a first converter provided between the electrical storage device and the load drive unit, and configured to perform voltage conversion between the electrical storage device voltage and the secondary voltage, and a second converter provided between the fuel cell and the load drive unit, and configured to perform voltage conversion between the fuel cell voltage and the secondary voltage. The method includes a secondary-voltage stepping-up step of controlling the first converter to thereby allow the secondary voltage to become higher than the fuel cell voltage, without following a change of required electrical power for the load.

In the present invention, by controlling the terminal voltage of the load drive unit, which is the secondary voltage, to become higher than the fuel cell voltage, it is possible to interrupt the output from the fuel cell. Accordingly, it is possible to prevent overcharging, etc. of the electrical storage device with surplus electrical power produced by the fuel cell.

Further, the method further includes, before the secondary-voltage stepping-up step, an electrical storage device charging-state determining step of determining whether or not charging of the electrical storage device with electrical power generated by the fuel cell is in an acceptable state. If it is determined that charging of the electrical storage device with the electrical power generated by the fuel cell is not in an acceptable state, the secondary-voltage stepping-up step is performed. In this manner, it is possible to interrupt charging of the electrical storage device with the electrical power generated by the fuel cell.

More specifically, in the electrical storage device charging-state determining step, preferably, a state of charge (SOC) of the electrical storage device is detected, and if the detected SOC is equal to or more than a SOC threshold value, the secondary-voltage stepping-up step is performed.

In a case where the SOC of the electrical storage device has a value which is equal to or higher than the SOC threshold value, there is a risk that charging of the electrical storage device may result in waste, or result in overcharging. Under the circumstance, by stepping up the secondary voltage, such a risk can be eliminated, and it is possible to prevent degradation of the fuel economy (electrical power efficiency) of the fuel cell system.

In this case, before the secondary-voltage stepping-up step, the first converter is placed in a stopped state to directly connect the electrical storage device to the load drive unit. In this manner, it is possible to improve the system efficiency.

Further, preferably, the method includes a power generation current zero-value setting step of setting power generation current to a zero value before controlling the first converter to thereby allow the secondary voltage to become higher than the fuel cell voltage. By setting the power generation current to a zero value, the fuel cell voltage becomes the OCV (open circuit voltage), and the output from the fuel cell can be interrupted reliably.

Further, according to another aspect of the present invention, a method of controlling a fuel cell system is provided. The fuel cell system includes a fuel cell configured to generate fuel cell voltage as a primary voltage, an electrical storage device configured to generate electrical storage device voltage as another primary voltage, a load drive unit to which a secondary voltage is supplied, the load drive unit being configured to drive a load, a first converter provided between the electrical storage device and the load drive unit, and configured to perform voltage conversion between the electrical storage device voltage and the secondary voltage, and a second converter provided between the fuel cell and the load drive unit, and configured to perform voltage conversion between the fuel cell voltage and the secondary voltage. The method includes a secondary-voltage setting step of setting the secondary voltage by the first converter depending on required electrical power for the load, and a secondary-voltage temporarily-fixing step of, when the secondary voltage decreases based on decrease in the required electrical power for the load and/or regenerative electrical power of the load, temporarily fixing the decreasing secondary voltage by the first converter.

In the present invention, by temporarily fixing the secondary voltage, it is possible to reduce the risk that the electrical power produced by the fuel cell is drawn out, and improve the controllability of the fuel cell.

In this case, preferably, the method further includes a SOC detecting step of detecting a state of charge (SOC) of the electrical storage device, and if the detected SOC is equal to or more than an SOC threshold value, the secondary-voltage temporarily-fixing step is performed. In a case where the SOC of the electrical storage device has a value which is equal to or higher than the SOC threshold value, there is a risk that charging of the electrical storage device may result in waste, or overcharging of the electrical storage device may occur. In such a case, by temporarily fixing the secondary voltage, it is possible to prevent overcharging of the electrical storage device, and improve the fuel economy (electrical power efficiency) of the fuel cell system.

In this regard, preferably, in a case where the decrease of the secondary voltage is caused by regenerative electrical power of the load, the secondary-voltage temporarily-fixing step continues until generation of the regenerative electrical power of the load is finished. In this manner, it is possible to reduce the risk of overcharging of the electrical storage device.

According to still another aspect of the present invention, a method of controlling a fuel cell automobile is provided. The fuel cell automobile includes a fuel cell configured to generate fuel cell voltage as a primary voltage, an electrical storage device configured to generate electrical storage device voltage as another primary voltage, a motor drive unit to which a secondary voltage is supplied, the motor drive unit being configured to drive a motor which produces driving power for allowing travel of the fuel cell automobile, a first converter provided between the electrical storage device and the motor drive unit, and configured to perform voltage conversion between the electrical storage device voltage and the secondary voltage, and a second converter provided between the fuel cell and the motor drive unit, and configured to perform voltage conversion between the fuel cell voltage and the secondary voltage. The method includes a deceleration determining step of determining whether or not the fuel cell automobile is in a deceleration state, and a secondary-voltage stepping-up step of, when the fuel cell automobile is in the deceleration state, controlling the first converter to thereby allow the secondary voltage to become higher than the fuel cell voltage.

Generally, at the time of deceleration of the fuel cell automobile, the electrical power of the fuel cell that becomes redundant (surplus) is used for charging the electrical storage device. Therefore, if the fuel cell electrical power is continuously generated, overcharging of the electrical storage device may occur. In such a case, according to the present invention, by increasing the terminal voltage of the motor drive unit, which is the secondary voltage, to exceed the fuel cell voltage, it is possible to interrupt the output from the fuel cell, and prevent overcharging of the electrical storage device.

According to another aspect of the present invention, a fuel cell automobile is provided. The fuel cell automobile includes a fuel cell configured to generate fuel cell voltage as a primary voltage, an electrical storage device configured to generate electrical storage device voltage as another primary voltage, a motor drive unit to which a secondary voltage is supplied, the motor drive unit being configured to drive a motor which produces driving power for allowing travel of the fuel cell automobile, a first converter provided between the electrical storage device and the motor drive unit, and configured to perform voltage conversion between the electrical storage device voltage and the secondary voltage, a second converter provided between the fuel cell and the motor drive unit, and configured to perform voltage conversion between the fuel cell voltage and the secondary voltage, a deceleration state detection sensor, and an electronic control unit connected to the fuel cell, the electrical storage device, the motor drive unit, the first converter, the second converter, and the deceleration state detection sensor. When the electronic control unit determines that the fuel cell automobile is in a deceleration state based on an output of the deceleration state detection sensor, the electronic control unit controls the first converter to thereby allow the secondary voltage to become higher than the fuel cell voltage.

In the present invention, it is possible to prevent overcharging of the electrical storage device with the surplus electrical power generated by the fuel cell.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a diagram schematically showing a structure of a fuel cell automobile according to an embodiment of the present invention;

FIG. 2 is a table showing operation of an FC converter and a BAT converter in FIG. 1;

FIG. 3 is a graph showing an I-V characteristic curve of a fuel cell stack;

FIG. 4 is a time chart used for explanation of operation according to a first embodiment example;

FIG. 5 is a flow chart used for explanation of operation according to the first embodiment example;

FIG. 6 is a time chart used for explanation of operation according to a modified example of the first embodiment example;

FIG. 7 is a flow chart used for explanation of operation according to the modified example of the first embodiment example;

FIG. 8 is a time chart used for explanation of operation according to a second embodiment example; and

FIG. 9 is a flow chart used for explanation of operation according to the second embodiment example.

### DESCRIPTION OF THE PREFERRED EMBODIMENTS

Hereinafter, preferred embodiments of a method of controlling a fuel cell system (fuel cell automobile) according to the present invention will be described in relation to a fuel cell automobile for carrying out the control method with reference to the accompanying drawings.

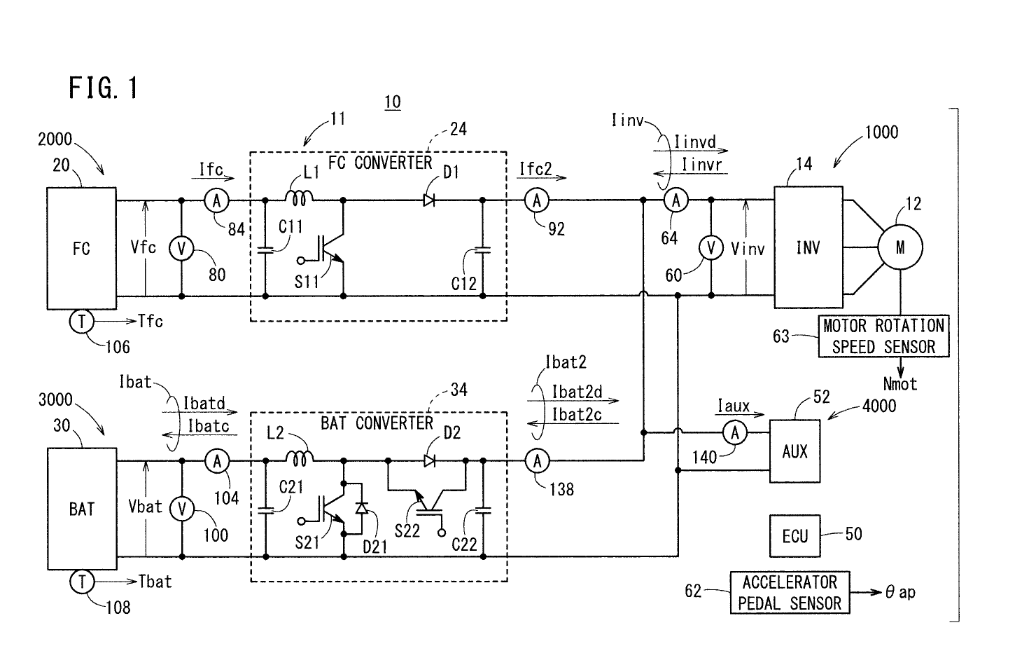

FIG. 1 is a diagram schematically showing structure of a fuel cell automobile 10 (hereinafter also referred to as “FC automobile” or “vehicle 10”) according to an embodiment of the present invention.

It should be noted that a fuel cell system in which the load is a motor 12 for traction (hereinafter also referred to as “traction motor 12”, “drive motor 12”, or simply “motor 12”) is referred to as the FC automobile 10. The fuel cell system according to the embodiment is applicable to plant facilities such as a factory facility where the load is a motor of a type different from the traction motor.

The FC automobile 10 includes a drive system 1000, a fuel cell system (hereinafter also referred to as the “FC system”) 2000, a battery system 3000, an auxiliary device system 4000, and an electronic control unit 50 (hereinafter also referred to as the “ECU 50”) for controlling the drive system 1000, the fuel cell system 2000, the battery system 3000, and the auxiliary device system 4000. For the purpose of brevity, wiring lines (signal lines, etc.) connecting the ECU 50 to respective constituent components are omitted in FIG. 1.

In the structure, the fuel cell system 2000 and the battery system 3000 basically function as parallel power sources for the entire vehicle 10. The drive system 1000 and the auxiliary device system 4000 basically function as a load which consumes electrical power supplied from the power sources (fuel cell system 2000 and battery system 3000).

The drive system 1000 includes the traction motor and an inverter 14 as a load drive unit (motor drive unit). The inverter 14 also functions as part of the load.

The FC system 2000 includes a fuel cell stack (fuel cell) 20 (hereinafter referred to as the “FC 20”) as the power source, a fuel cell converter 24 (hereinafter referred to as the “FC converter 24”), a fuel gas supply source (not shown) such as a fuel tank, and an oxygen-containing gas supply source (not shown).

The FC converter 24 is a chopper type step-up converter (voltage boost converter). As shown in FIG. 1, for example, the FC converter 24 includes a choke coil (inductor) L1, a diode D1, a switching element (transistor) S11, and smoothing capacitors C11 and C12.

The battery system 3000 includes a battery (hereinafter also referred to as the “BAT”) 30 as an electrical storage device, and a battery converter 34 (hereinafter also referred to as the “BAT converter 34”).

The BAT converter 34 is a chopper type step-up/down converter (voltage boost/buck converter). As shown in FIG. 1, for example, the BAT converter 34 includes a choke coil (inductor) L2, diodes D2 and D21, switching elements (transistors) S21 and S22, and smoothing capacitors C21 and C22.

Though not shown, the auxiliary device system 4000 includes auxiliary devices (AUX) 52 such as an air pump as an oxygen-containing gas supply source for the FC 20 and an air conditioner in the high voltage system, and lighting devices and a low voltage electrical storage device (low voltage power source), etc. in the low voltage system.

When the drive system 1000 is driven as a load by electrical power supplied from the FC 20 and the battery 30, the motor 12 produces a drive power for allowing travel of the FC automobile 10. That is, the drive power is transmitted through a transmission (not shown) to rotate wheels (not shown) for moving the FC automobile 10.

The inverter 14 is a DC/AC converter operated in a bi-directional manner. At the time of power-running of the FC automobile 10, the inverter 14 converts the inverter terminal voltage (load terminal voltage) Vinv, which is a DC voltage, and the inverter terminal current Iinv (power-running current Iinvd) generated at the input terminal of the inverter 14 by the FC 20 and/or the battery 30 into three phase AC voltage and AC current, and applies the three phase AC voltage and AC current to the motor 12.

Further, at the time of regeneration of the FC automobile 10 (at the time of deceleration when the value of the opening degree (accelerator pedal opening degree) eap indicated by an accelerator pedal sensor 62 connected to the an accelerator pedal (not shown) is zero), the inverter 14 converts the AC regenerative electrical power generated at the motor 12 into DC inverter terminal voltage Vinv and inverter terminal current Iinv (regenerative current Iinvr). By the electrical power generated by regeneration by the motor 12 (regenerative electrical power), charging of the battery 30 is performed through the BAT converter 34 that is placed in the voltage step-down state.

The inverter terminal voltage Vinv which is the secondary voltage common to the FC converter 24 and the BAT converter 34 is detected by a voltage sensor 60, and outputted to the ECU 50 through a signal line (not shown). The inverter terminal current Iinv as the input terminal current of the inverter 14 is detected by a current sensor 64, and outputted to the ECU 50 through a signal line (not shown).

The ECU 50 includes an input/output device, a computing device (including CPU), and a storage device (these devices are not shown). For example, the ECU 50 may be divided into an ECU for the drive system 1000, an ECU for the FC system 2000, an ECU for the battery system 3000, an ECU for the auxiliary device system 4000, an ECU for driving the FC converter 24, an ECU for driving the BAT converter 34, and an ECU for controlling these components as a whole. In this case, these ECUs can communicate with one another.

For example, the FC 20 is formed by stacking fuel cells. Each of the fuel cells includes an anode, a cathode, and a solid polymer electrolyte membrane interposed between the anode and the cathode. An anode system including the fuel gas supply source, a cathode system including the oxygen-containing gas supply source, a coolant system, etc. are provided around the FC 20. The anode system supplies hydrogen (fuel gas) to the anode of the FC 20, and discharges the hydrogen from the anode of the FC 20. The cathode system supplies the air (oxygen-containing gas) to the cathode of the FC 20, and discharges the air from the cathode. The coolant system cools the FC 20.

The FC converter 24 is provided between the FC 20 and the inverter 14. The primary side of the FC converter 24 is connected to the FC 20, and the secondary side of the FC converter 24 is connected to the motor 12 through the inverter 14, and connected to the battery 30 through the BAT converter 34.

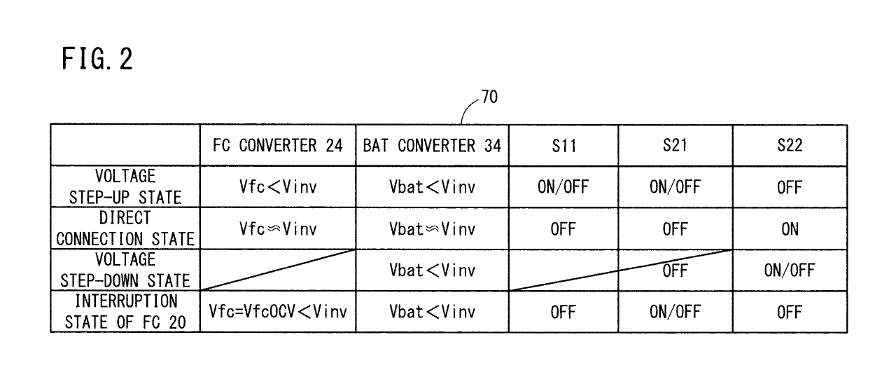

FIG. 2 is a table 70 illustrating the drive states of the switching elements S11, S21, S22 by the ECU 50, the operating states (voltage step-up state, direct connection state, voltage step-down state) of the FC converter 24 and the BAT converter 34, and the magnitude relationship between the primary voltage (FC voltage Vfc, battery voltage Vbat) and the secondary voltage (inverter terminal voltage Vinv) of the FC converter 24 and the BAT converter 34.

The FC converter 24 steps up the FC voltage Vfc, which is the output voltage of the FC 20 (i.e., implements duty control of ON/OFF of the switching element S11 (i.e., repeatedly switches between an ON state and an OFF state)), or directly connects the FC voltage Vfc to the secondary side (i.e., places the switching element S11 in the OFF state), and applies the FC voltage Vfc as the inverter terminal voltage Vinv to the secondary side (the inverter of the drive system 1000, the auxiliary devices 52, and/or the battery 30).

When the FC 20 is in an interruption state, in the FC converter 24, the switching element S11 is placed in the OFF state, whereby the inverter terminal voltage Vinv becomes higher than the open circuit voltage (FC open circuit voltage) VfcOCV of the FC 20 (the diode D1 is in the interruption state (OFF state)).

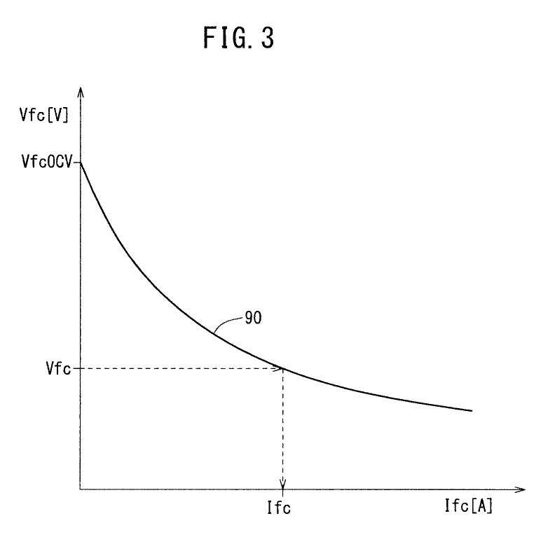

FIG. 3 is a graph showing an I-V (current-voltage) characteristic curve 90 of the FC 20. According to the I-V characteristic curve 90, as the FC voltage Vfc decreases with respect to the FC open circuit voltage VfcOCV, the FC current Ifc increases. Further, according to the I-V characteristic curve 90, as the FC current Ifc increases (i.e., as the FC voltage Vfc decreases), the FC electrical power Pfc increases. For example, when the FC voltage Vfc, which is the primary voltage of the FC converter 24, is set to a command voltage, the voltage step-up ratio (Vinv/Vfc) of the FC converter 24 is determined such that the FC voltage Vfc reaches the command voltage, and the FC current Ifc corresponding to the FC voltage Vfc that has reached the command voltage flows in accordance with the I-V characteristic curve 90.

When the FC converter 24 is in the voltage step-up state, the FC voltage Vfc as the primary voltage of the FC converter 24 is lower than the inverter terminal voltage Vinv (Vfc<Vinv).

When the FC converter 24 is in the direct connection state, the inverter terminal voltage Vinv becomes equal to the FC voltage Vfc (to be exact, Vinv=Vfc−Vd1 where Vd1 is the forward drop voltage of the diode D1), and the value of the switching loss of the FC converter 24 becomes zero. Therefore, improvement in the system efficiency of the FC automobile 10 is achieved as a whole.

When the FC converter 24 is in the direct connection state, if the inverter terminal voltage Vinv as the secondary voltage of the FC converter 24 becomes higher than the FC open circuit voltage VfcOCV (Vinv>VfcOCV), then operation of the FC converter 24 is stopped, whereby the value of the FC current Ifc flowing from the FC 20 becomes zero (Ifc=0). That is, the FC 20 is placed in the interruption state.

Likewise, when the BAT converter 34 is in the direct connection state, the inverter terminal voltage Vinv becomes equal to the battery voltage Vbat (to be exact, Vinv=Vbat−Vd2 where Vd2 is the forward drop voltage of the diode D2), and the value of the switching loss of the BAT converter 34 becomes zero. Therefore, improvement in the system efficiency of the FC automobile 10 is achieved as a whole.

The FC voltage Vfc as the primary voltage of the FC converter 24 is detected by a voltage sensor 80, and outputted to the ECU 50 through a signal line (not shown). The FC current Ifc as the primary side current of the FC converter 24 is detected by a current sensor 84, and outputted to the ECU 50 through a signal line (not shown). The secondary voltage of the FC converter 24 is detected as the inverter terminal voltage Vinv by the voltage sensor 60. The secondary current Ifc2 of the FC converter 24 is detected by a current sensor 92, and outputted to the ECU 50 through a signal line (not shown). The temperature Tfc [° C.] of the FC 20 (FC temperature) is detected by a temperature sensor 106, and outputted to the ECU 50 through a signal line (not shown).

The battery 30 is an electrical storage device (energy storage) including a plurality of battery cells. For example, a lithium ion secondary battery, a nickel hydrogen secondary battery, etc. can be used as the battery 30. In the embodiment, the lithium ion secondary battery is used. Instead of the battery 30, other types of energy storage such as a capacitor may be used.

The battery voltage Vbat [V] as the input/output terminal voltage of the battery 30 is detected by a voltage sensor 100, and outputted to the ECU 50 through a signal line (not shown).

The battery current Ibat (discharging current Ibatd or charging current Ibatc) [A] of the battery 30 is detected by a current sensor 104, and outputted to the ECU through a signal line (not shown). The temperature (battery temperature) Tbat [° C.] of the battery 30 is detected by a temperature sensor 108, and outputted to the ECU 50 through a signal line (not shown).

The ECU 50 calculates the state of charge (hereinafter referred to as the “SOC” or the “battery SOC”) [%] of the battery 30 based on the battery temperature Tbat, the battery voltage Vbat, and the battery current Ibat, and uses the calculated SOC for management of the battery 30.

For example, based on the battery temperature Tbat and the SOC, the ECU 50 calculates the upper limit SOCuplmt [kW] as an upper limit value of the SOC, and the charging limit electrical power Pbatmgn [kW] for reaching the upper limit SOCuplmt [kW].

When the SOC of the battery 30 becomes higher than the upper limit SOCuplmt, or after the charging limit electrical power Pbatmgn as allowable electrical power that can be accepted as the charging power by the battery 30 has reached 0 [kW], overcharging of the battery 30 may occur, and the battery 30 may be degraded undesirably.

As described above, the BAT converter 34 steps up the output voltage (battery voltage Vbat) of the battery 30 {Vbat<Vinv, voltage step-up ratio (Vinv/Vbat)>1}, and supplies the stepped-up voltage to the inverter 14 (in the voltage step-up state). Further, the BAT converter 34 steps down the regenerative voltage (hereinafter referred to as the “regenerative voltage Vreg”) of the motor 12 or the secondary voltage (inverter terminal voltage Vinv) of the FC converter 24 {Vbat<Vinv, voltage step-down ratio (Vbat/Vinv)<1}, and supplies the stepped-down voltage to the battery 30 (in the voltage step-down state).

The BAT converter 34 is provided between the battery 30 and the inverter 14. One side of the BAT converter 34 is connected to the primary side where the battery 30 is present, and the other side of the BAT converter 34 is connected to the secondary side as a connection point between the FC 20 and the inverter 14.

As described above, the battery voltage Vbat as the primary voltage of the BAT converter 34 is detected by the voltage sensor 100, and the battery current Ibat as the primary current of the BAT converter 34 is detected by the current sensor 104.

The secondary voltage of the BAT converter 34 is detected as the inverter terminal voltage Vinv by a voltage sensor 60. The secondary side current Ibat2 (discharging current Ibat2d, charging current Ibat2c) of the BAT converter 34 is detected by a current sensor 138, and outputted to the ECU 50 through a signal line (not shown).

The auxiliary device current Iaux flowing through the auxiliary devices 52 is detected by a current sensor 140, and outputted to the ECU 50 through a signal line (not shown).

The ECU 50 controls the motor 12, the inverter 14, the FC 20, the battery 30, the FC converter 24, and the BAT converter 34. In the control, the ECU 50 executes a program stored in a storage device (not shown). Further, the ECU 50 uses detection values of various sensors such as the voltage sensors 60, 80, 100 and the current sensors 64, 84, 92, 104, 138, and 140.

In addition to the above sensors, the various sensors herein includes an accelerator pedal sensor 62 for detecting the opening degree (operation amount) θap [%] of the above accelerator pedal, a motor rotation speed sensor 63, and wheel speed sensors (all not shown). The motor rotation speed sensor 63 is made up of a resolver, etc., and detects the rotation speed Nmot [rpm] of the motor 12. The ECU 50 detects the vehicle velocity Vs [km/h] of the vehicle 10 based on the rotation speed Nmot. The wheel speed sensors detect speeds (vehicle speeds) of vehicle wheels (not shown). During the travel of the vehicle 10, if the opening degree eap of the accelerator pedal is 0 (θap=0), the vehicle 10 is in the deceleration state. Therefore, the accelerator pedal sensor 62 also functions as a deceleration state detection sensor. Further, since the vehicle velocity Vs is detected by the motor rotation speed sensor 63, the motor rotation speed sensor 63 also functions as a deceleration state detection sensor (if the derivative value of the vehicle velocity Vs has a negative value, the vehicle 10 is in the deceleration state).

The ECU 50 calculates the system required electrical power Psysreq [kW] which is a system load (entire load) required for the entire FC automobile 10, based on the inputs (load requirements) from various switches and various sensors, in addition to the state of the FC 20, the state of the battery 30, the state of the motor 12, and the states of the auxiliary devices 52.

Further, the ECU 50 balances and determines the allocation (sharing) of the required FC electrical power Pfcreq for the load powered by the FC 20 (FC load), the required battery electrical power Pbatreq for the load powered by the battery 30 (battery load), and the regenerative electrical power Preg for the load powered by the regenerative power source (motor 12) (regenerative load), based on the system required electrical power Psysreq.

### [Explanation of Control Method and Operation]

Next, a first embodiment example, a modified example of the first embodiment example, and a second embodiment example of a control method of an FC automobile according to this embodiment will be described.

### First Embodiment Example

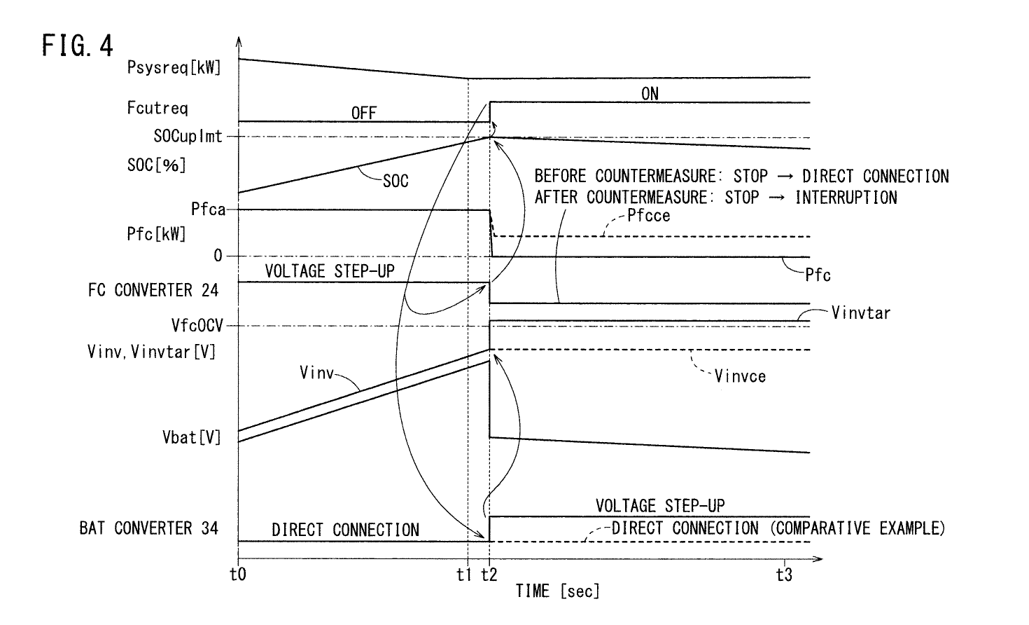

FIG. 4 is a time chart used for explaining operation of the FC automobile 10 (FIG. 1) for implementing a control method of the first embodiment example.

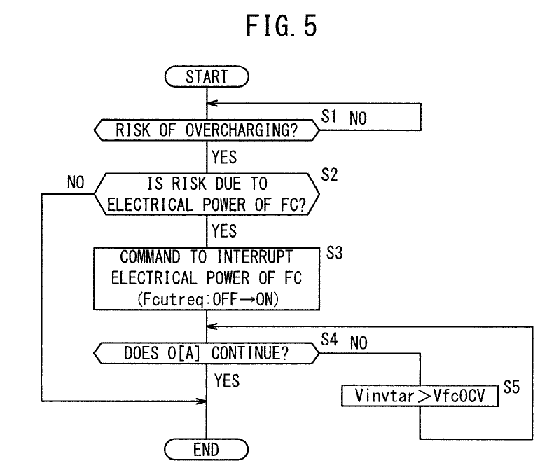

FIG. 5 is a flow chart used for explanation of the control method according to the first embodiment example.

During the period from the time point t0 to the time point t1 (deceleration period, etc.), the system required electrical power Psysreq of the FC automobile 10 is decreased gradually.

During the period from the time point t1 to the time point t3, the FC automobile 10 is placed in an idling stop state (i.e., a no-idling state or an idle-reduction state) where the value of the vehicle velocity is zero. The system required electrical power Psysreq is kept at a low electrical power in correspondence with the idling stop state.

During the period from the time point t0 to the time point t2, in order to improve the system efficiency, the BAT converter 34 is controlled to be placed in the direct connection state (Vbat≈Vinv). In this case, the switching element S21 of the BAT converter 34 is kept in the OFF state, and the switching element S22 of the BAT converter 34 is kept in the ON state (FIG. 2).

During the period from the time point t0 to the time point t2, the FC 20 generates a fixed FC electric power Pfca (=Pfc).

During the period from the time point t0 to the time t2, since the BAT converter 34 is placed in the direct connection state, the battery 30 is charged with the surplus FC electrical power Pfca through the FC converter 24 in the voltage step-up state and the BAT converter 34 in the direct connection state, and as a result, the battery voltage Vbat and the inverter terminal voltage Vinv are gradually increased at substantially the same voltage level (Vbat=Vinv−ON voltage of the switching element S22).

The voltage step-up ratio (Vinv/Vfc) of the FC converter 24 is controlled in a manner that the voltage step-up ratio (Vinv/Vfc) is increased with the inclination which is the same as the inclination of the voltage rise of the inverter terminal voltage Vinv. As a consequence of this control, the target FC electric power Pfctar will be the fixed FC electrical power Pfca.

Even after the time point t1 when the FC automobile 10 is stopped, by charging of the battery 30 with the surplus electrical power in the FC electrical power Pfca, the SOC is increased gradually.

During charging of the battery 30, in step S1, the ECU 50 determines whether or not there is a risk of overcharging of the battery 30.

At the time point t2 when the FC automobile 10 is stopped, the SOC gets closer to the upper limit SOCuplmt (under the practical control, the SOC gets closer to a threshold value which is smaller than the upper limit SOCuplmt considering a margin), and then the ECU 50 determines that there is a risk of overcharging (step S1: YES).

In step S2, the ECU 50 determines whether or not the cause of this risk of overcharging is due to the surplus electrical power of the FC electrical power Pfc. If the cause of the risk of overcharging is not due to the surplus electrical power of the FC electrical power Pfc (step S2: NO), the processing sequence of the flow chart is finished.

In this case, based on the value of the current sensor 64, it is confirmed that the regenerative electrical power is not present, and it is determined from the values (Vfc, Ifc) of the voltage sensor 80 and the current sensor 84 that the cause of the risk of overcharging is due to the surplus electrical power of the FC electrical power Pfc (step S2: YES).

At this time, in step S3, the ECU 50 generates a command of Ifc=0 [A] for the FC 20 (FC electrical power interruption command), and in step S3, the switching element S11 is switched from the ON/OFF switching state to the OFF state, for switching the FC converter 24 from the voltage step-up state to the interruption state.

In practice, at the time point t2, a power generation interruption request flag Fcutreq of the FC 20 is switched from an OFF state to an ON state (step S3).

Therefore, the FC converter 24 is switched from the voltage step-up state to a stopped state (step S3).

Then, in step S4, it is checked whether or not the value of the FC current Ifc is zero (Ifc=0 [A] or not).

Now, the step of keeping the value of the FC current Ifc at zero (Ifc=0 [A]) will be described briefly. In practice, in the FC automobile 10, the FC voltage Vfc is in the order of about several hundreds of bolts. However, for the purpose of brevity, it is assumed that the forward drop voltage Vd1 of the diode D1 is Vd1=[V], the current FC voltage Vfc is Vfc=1.0 [V], the inverter terminal voltage Vinv is Vinv=1.2 [V], and the FC open circuit voltage VfcOCV is VfcOCV=1.5 [V].

In this example, when the FC converter 24 is placed in the OFF state (step S3), since Vfc=1.0<1.2=Vinv (Vfc<Vinv), the diode D1 is placed in the OFF state by the reverse bias, and has a current value of 0 [A] instantaneously. However, since the FC voltage Vfc is increased from 1.0 [V] to 1.5 [V] (FC open circuit voltage VfcOCV), if this circumstance goes on, the FC voltage Vfc exceeds 1.2 [V] (Vfc>Vinv), and thus, the FC converter 24 is placed in the so called direct connection state. Consequently, the FC current Ifc changes immediately, so that it cannot be kept at 0 [A] (step S4: NO).

Therefore, in step S5, the inverter terminal command voltage Vinvtar (hereinafter also referred to as the “target inverter terminal voltage Vinvtar”) is set to have a voltage value that is more than the FC open circuit voltage VfcOCV at the current FC temperature Tfc, and the BAT converter 34 is switched from the direct connection state for battery charging to the voltage step-up state for stepping up the battery voltage Vbat.

That is, during the idling stop period from the time point t2 to the time point t3, the ECU 50 increases the inverter terminal command voltage Vinvtar, which is a secondary voltage command for the BAT converter 34, in a stepwise manner such that the following equation (1) is satisfied.

VfcOCV<Vinvtar=Vinv (1)

Then, the voltage step-up ratio (Vinvtar/Vbat) of the BAT converter 34 is controlled in a manner to have this inverter terminal command voltage Vinvtar.

In this manner, since the FC electrical power Pfc is interrupted reliably (Pfc=0 [kW]), determination of step S4 (0 [A] continues?) becomes affirmative (YES), and the SOC of the battery 30 is decreased gradually after the time point t2 without reaching the upper limit SOCuplmt.

In step S5, the reason of setting the inverter terminal command voltage Vinvtar to the voltage value that is more than the FC open circuit voltage VfcOCV at the current FC temperature Tfc is to consider the fact that, for example, at freezing temperature or less, in comparison with the case of room temperature of about 20 [° C.], the FC open circuit voltage VfcOCV becomes higher.

In the time chart of FIG. 4, a comparative example which is not subjected to any countermeasure is shown by broken lines after the time point t2. In the comparative example, the inverter terminal voltage Vinv was not controlled because the inverter terminal voltage Vinv is not directly related to the FC electrical power Pfc. Thus, after the time point t2, the inverter terminal voltage Vinv of the comparative example without any control is shown as an inverter terminal voltage Vinvce.

Further, in the FC converter of the comparative example, since the stop command (command to turn off the switching element S11) is issued after the time point t2, as described above, the direct connection state may continue after the time point t2. In this case, the FC electrical power Pfc does not becomes 0 [kW], but the FC electrical power Pfcce of the comparative example continues. Thus, in the comparative example, the FC electrical power Pfcce is transmitted to the battery 30 through the BAT converter 34 that is placed in the direct connection state, and the FC current Ifc from the FC 20 is continuously supplied into the battery 30 undesirably.

In the flow chart of FIG. 5, since it is already determined in step S3 that there is a risk of overcharging of the battery 30 by the FC electrical power Pfc (step S1: YES, step S2: YES), the determination process in step S4 may be omitted to directly perform the process in step S5 (step-up process by the control of the BAT converter 34 to satisfy Vinvtar>VfcOCv).

### Summary of First Embodiment Example

The FC automobile 10 in which the method of controlling the FC automobile 10 according to the above first embodiment example is carried out includes the FC 20 for generating the FC voltage Vfc as a primary voltage, the battery 30 for generating the battery voltage Vbat as another primary voltage, the inverter 14 for driving the motor 12, the BAT converter 34 (first converter) provided between the battery 30 and the inverter 14 and configured to perform voltage conversion between the battery voltage Vbat and the inverter terminal voltage Vinv, and the FC converter 24 (second converter) provided between the FC 20 and the inverter 14 and configured to perform voltage conversion between the FC voltage Vfc and the inverter terminal voltage Vinv.

The control method of the first embodiment example includes an electrical storage device charging-state determining step (step S1) of determining whether or not charging of the battery 30 with the FC electrical power Pfc, which is the electrical power generated by the FC 20, is in an acceptable state.

This electrical storage device charging-state determining step is carried out as a SOC detection step (step S1) from the time point t0 in FIG. 4, for example. As shown at the time point t1, when the SOC of the battery 30 gets closer to the upper limit SOCuplmt (gets closer to a threshold value which is smaller than the upper limit SOCuplmt considering a margin), a negative determination is made (i.e., the charging is not in an acceptable state, step S1: NO), and then the power generation interruption request flag Fcutreq is switched from the OFF state to the ON state (Step S3).

The control method according to the first embodiment example further includes a secondary-voltage stepping-up step (step S5). In the secondary-voltage stepping-up step, in a case where charging of the battery is not in an acceptable state (step S1: YES), the BAT converter 34 is controlled in a manner that the inverter terminal voltage Vinv, which is the secondary voltage common to the BAT converter 34 and the FC converter 24, becomes higher than the FC open circuit voltage VfcOCV, without following the change in the system required electrical power Psysreq (chiefly, electrical power of the motor 12 as the load). Stated otherwise, the control of the inverter terminal voltage Vinv in conjunction with the change of load (the motor 12) is stopped. In the example of FIG. 4, the system required electrical power is decreased gradually during the period from the time point t0 to the time point t1, and reaches a fixed value at the time point t1. Thereafter the system required electrical power is kept at the fixed value from the time point t1 to the time point t3.

As shown at the time point t2, the voltage step-up operation of the FC converter 24 is stopped (S11: OFF), and by the voltage step-up operation of the BAT converter (S21: ON/OFF switching, S22: OFF), the inverter terminal voltage Vinv as the secondary voltage is increased stepwise to exceed the FC open circuit voltage VfcOCV. As a result, it is possible to instantaneously interrupt the output from the FC 20, and consequently it is possible to prevent charging of the battery 30 with the surplus electrical power of the FC 20.

That is, in a case where the SOC of the battery 30 is equal to or more than the upper limit SOCuplmt, which is a SOC threshold value, charging of the battery 30 may be wasteful, or overcharging of the battery 30 may occur undesirably. In this case, by stepping up the inverter terminal voltage Vinv to become the FC open circuit voltage VfcOCV or more (Vinvtar=Vinv>VfcOCV) by the BAT converter 34, since the step-up type FC converter 24 is placed in the interruption state (switching element S11 is placed in the OFF state, whereby reverse bias is applied to the diode D1), it is possible to prevent wasteful charging and overcharging of the battery 30 with the surplus electrical power of the FC 20. Further, the output of the FC 20 is interrupted, and accordingly, it is possible to prevent degradation of the fuel economy (electric power efficiency) of the FC automobile 10.

Additionally, before the step of stepping up the inverter terminal voltage Vinv (the secondary-voltage stepping-up step) which is performed after the time point t2, by implementing a control to place the BAT converter 34 in the stopped state to thereby directly connect the battery 30 to the inverter 14 through the switching element S22 (or the diode D2), improvement in the system efficiency is achieved.

Further, since a power generation current zero-value setting step (step S3) of setting the FC current Ifc, which is the output current from the FC 20, to have a zero value (Ifc=0 [A]) before controlling the BAT converter 34 (step S5) for allowing the inverter terminal voltage (Vinv) to become higher than the FC voltage (Vfc) is provided, the FC voltage Vfc of the FC 20 becomes closer to the FC open circuit voltage VfcOCV, and thus, the output from the FC 20 can be interrupted reliably.

### Modified Example of the First Embodiment Example

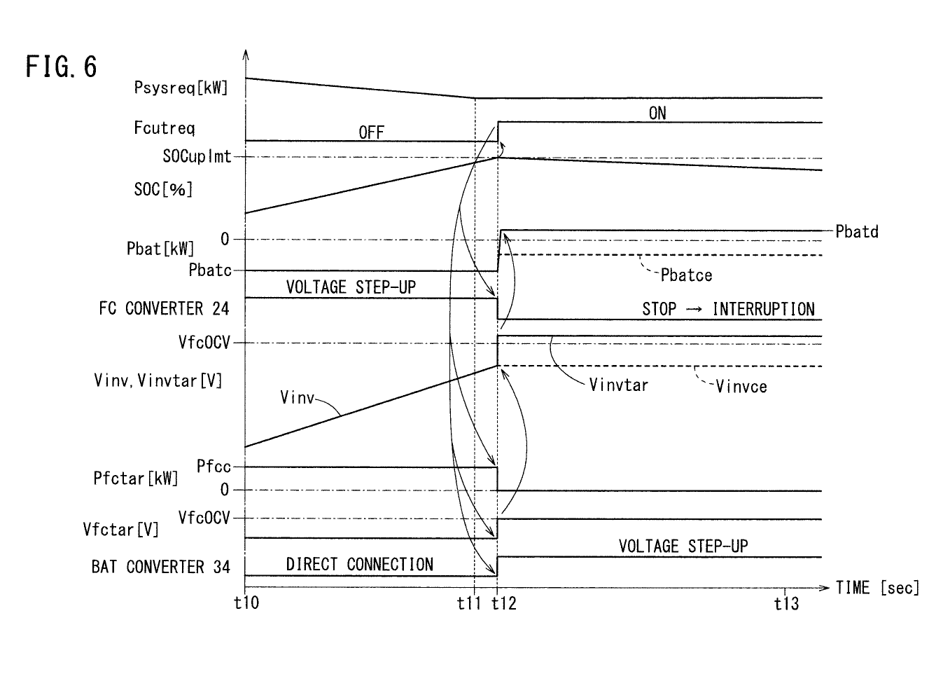

FIG. 6 is a time chart used for explaining operation of the FC automobile 10 for carrying out the control method of a modified example of the first embodiment example.

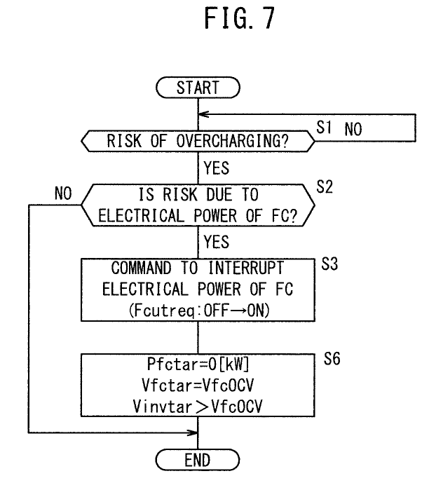

FIG. 7 is a flow chart used for explaining operation of the control method of the modified example of the first embodiment example. In comparison with the flow chart of FIG. 5, in this flow chart, the process in step S4 is omitted, and the process of step S5 in FIG. 5 is changed to (replaced by) the process of step S6.

At the time of deceleration, etc. of the FC automobile 10 in the period from the time point t10 to the time point t11 (deceleration period, etc.), the system required electrical power Psysreq is decreased gradually.

During the period from the time point t11 to the time point t13, the FC automobile 10 is placed in the idling stop state where the value of the vehicle velocity is zero. The system required electrical power Psysreq is kept at a low electrical power in correspondence with the idling stop state.

During the period from the time point t10 to the time point t12, control is implemented to place the BAT converter 34 in the direct connection state for improving the system efficiency.

During the period from the time point t10 to the time point t12, FC 20 generates a fixed FC electrical power Pfcc.

In this case, during the period from the time point t10 to the time point t12, since the BAT converter 34 is placed in the direct connection state, the battery 30 is charged with the surplus FC electrical power Pfcc through the FC converter 24 in the voltage step-up state and the BAT converter 34 in the direct connection state. The battery voltage Vbat and the inverter terminal voltage Vinv are gradually increased at substantially the same voltage level (Vbat=Vinv−ON voltage of the switching element S22).

The voltage step-up ratio (Vinv/Vfc) of the FC converter 24 is controlled in a manner that the voltage step-up ratio (Vinv/Vfc) is decreased with the inclination which is opposite to the inclination of the voltage rise of the inverter terminal voltage Vinv. As a consequence of this control, the target FC electrical power Pfctar will be the fixed FC electrical power Pfcc.

Even after the time point t11 at which the FC automobile 10 is stopped, the SOC is increased gradually by charging of the battery 30.

During charging of the battery 30, in step S1, the ECU 50 determines whether there is a risk of overcharging of the battery 30.

At the time point t12 at which the FC automobile 10 is stopped, when the SOC gets closer to the upper limit SOCuplmt (get closer to a threshold value considering the margin with respect to the upper limit SOCuplmt), the ECU determines that there is a risk of overcharging (step S1: YES).

In step S2, the ECU 50 determines whether or not the cause of this risk of overcharging is due to the surplus electrical power of the FC electrical power Pfc. If the cause of the risk of overcharging is not due to the surplus electrical power of the FC electrical power Pfc (step S2: NO), the operation sequence of the flow chart is finished.

In this case, based on the value of the current sensor 64, it is confirmed that the regenerative electrical power is not present, and it is determined from the values (Vfc, Ifc) of the voltage sensor 80 and the current sensor that the cause of the risk of overcharging is due to surplus electrical power of the FC electrical power Pfc (step S2: YES).

At this time, in step S3, the ECU 50 generates a command of Ifc=0 [A] for the FC 20 (FC electrical power interruption command), and in step S3, the switching element S11 is switched from the ON/OFF switching state to the OFF state for switching the FC converter 24 from the voltage step-up state to the interruption state.

In practice, at the time point t12, the power generation interruption request flag Fcutreq of the FC 20 is switched from the OFF state to the ON state (step S3).

Therefore, the FC converter 24 is switched from the voltage step-up state to the stopped state (step S3).

Then, in step S6, the target FC electrical power Pfctar is set to 0 [kW] from the FC electrical power Pfcc, and the target FC voltage Vfctar is set to the FC open circuit voltage VfcOCV in correspondence with the FC temperature Tfc.

Simultaneously, in step S6, the BAT converter 34 is switched from the direct connection state in the charging direction to the voltage step-up state for stepping up the battery voltage Vbat in the discharging direction.

That is, during the idling stop period from the time point t12 to the time point t13, the ECU 50 increases the inverter terminal command voltage Vinvtar as a secondary voltage command for the BAT converter 34 in a stepwise manner so as to satisfy the above equation (1).

In this manner, since the FC electrical power Pfc is interrupted (Pfc=0 [kw]), the SOC of the battery 30 is decreased gradually after the time point t12 without reaching the upper limit SOCuplmt.

In this case, during the idling stop period after the time point t12, since components such as the navigation device, the lighting device, the air conditioner, etc. among the auxiliary devices 52 (auxiliary device load) are operated, discharging of the battery 30 is performed, that is, the battery electrical power Pbat is placed in a battery electrical power Pbatd (which indicates a discharging state). It should be noted that charging of the battery 30 is performed until the time point t12, that is, the battery electrical power Pbat is in a battery electrical power Pbatc (which indicates a charging state).

In the time chart of FIG. 6, a comparative example which is not subjected to any countermeasures is shown by broken lines after the time point t12. In the comparative example, the inverter terminal voltage Vinv is not controlled because the inverter terminal voltage Vinv is not directly related to the FC electrical power Pfc. Therefore, after the time point t12, the inverter terminal voltage Vinv becomes the inverter terminal voltage Vinvce of the comparative example without any control.

After the time point t12, in the comparative example, since the battery electrical power Pbat becomes battery electrical power Pbatce for battery charging, battery charging continues, and the battery electrical power Pbat may exceed the battery upper limit SOCuplmt undesirably.

In contrast, in the control method of the modified example of the first embodiment example, at the time of interrupting the FC electrical power Pfc, the target FC electrical power Pfctar is set to zero, and the target FC voltage Vfctar is set to the FC open circuit voltage VfcOCV. Moreover, the inverter terminal voltage Vinv as the secondary voltage is stepped up to the voltage exceeding the FC open circuit voltage VfcOCV. Thus, the FC electrical power Pfc can be interrupted reliably, and overcharging of the battery 30 can be avoided appropriately.

### Second Embodiment Example

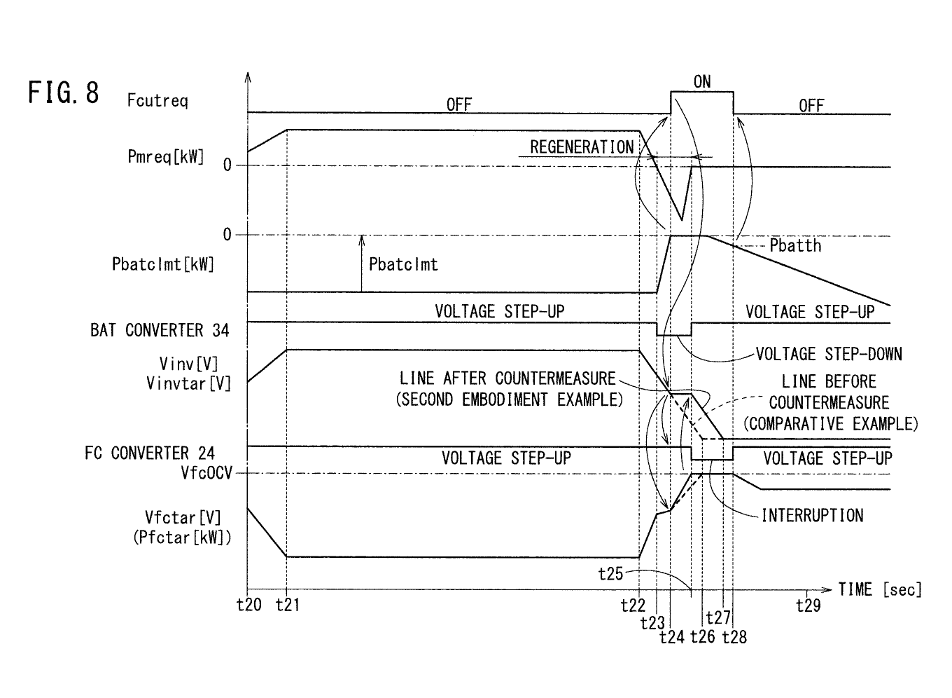

FIG. 8 is a time chart used for explaining operation of the FC automobile 10 for carrying out the control method of the second embodiment example.

During a time period of gradual acceleration of the FC automobile 10 from the time point t20 to the time t21 where the motor required electrical power Pmreq is increased gradually, in order to cover the gradual increase of the motor required electrical power Pmreq, the inverter terminal voltage Vinv (and likewise, the target inverter terminal voltage Vinvtar) is increased gradually, and the target FC electrical power Pfctar is increased gradually as well.

It should be noted that the gradual increase of the target FC electrical power Pfctar is achieved by the gradual decrease of the target FC voltage Vfctar (i.e., gradual increase of the FC current Ifc).

In practice, during the period from the time point t20 to the time point t21, the secondary voltage of the BAT converter 34 is set to the target inverter terminal voltage Vinvtar, and the BAT converter 34 steps up the voltage while gradually increasing the voltage step-up ratio Vinvtar/Vbat. During the period from the time point t20 to the time point t21, the FC converter 24 decreases the voltage step-up ratio Vinv/Vfctar gradually.

During a time period of constant-velocity traveling (constant-velocity travel period) of the FC automobile 10 from the time point t21 to the time point t22 where the motor required electrical power Pmreq is kept at a constant value, the voltage step-up ratio of the BAT converter 34 is controlled in a manner that the secondary voltage of the BAT converter 34 becomes the target inverter terminal voltage Vinvtar. During the period from the time point t21 to the time point t22, the voltage step-up ratio of the FC converter 24 is controlled in a manner that the target primary voltage of the FC converter 24 becomes the target FC voltage Vfctar. During the period from the time point t21 to the time point t22, the accelerator pedal opening degree θp is kept constant.

During the period from the time point t21 to the time point t22, the battery charging limit electrical power Pbatclmt indicating the allowable amount of the charging electrical power of the battery 30 has a value with a margin. If the battery charging limit electrical power Pbatclmt becomes 0 [kW], such a situation represents that the battery charging limit electrical power Pbatclmt has no margin.

From the time point t22, the accelerator pedal opening degree θp is gradually decreased, and deceleration of the FC automobile 10 is started. At the time point t23, the value of the accelerator pedal opening degree θp becomes zero (θp=0, Pmreq=0 [kW]), i.e., the accelerator pedal is released, and regeneration during deceleration is started from the time point t23.

During the period from the time point t22 to the time point t23, the voltage step-up ratio of the BAT converter 34 is controlled to decrease the inverter terminal voltage Vinv, and the voltage step-up ratio of the FC converter 24 is controlled in a manner to increase the target FC voltage Vfctar.

At the time point t23 when regeneration is started, the BAT converter 34 is switched from the voltage step-up state to the voltage step-down state.

At the time point t23, charging of the battery 30 is started by regeneration. Thereafter, the margin of the battery charging limit electrical power Pbatclmt is reduced rapidly. At the time point t24 when the margin gets close to 0 [kW], the ECU 50 switches the power generation interruption request flag Fcutreq of the FC 20 from the OFF state to the ON state.

When the power generation interruption request flag Fcutreq is placed in the ON state, the ECU 50 immediately starts the process of fixing the target inverter terminal voltage Vinvtar, which is the target secondary voltage of the BAT converter 34, to the inverter terminal voltage Vinv of the time point t24.

Then, during the period from the time point t24 to the time point t25 where the inverter terminal voltage Vinv is fixed, the target FC voltage Vfctar as the target primary voltage of the FC converter 24 is set to the FC open circuit voltage VfcOCV, and the FC voltage Vfc is increased by the FC converter 24 to follow the target FC voltage Vfctar (by linearly reducing the voltage step-up ratio of the FC converter 24, the FC voltage Vfc is brought closer to the FC open circuit voltage VfcOCV).

At the time point t25, when the FC voltage Vfc becomes equal to the FC open circuit voltage VfcOCV by operation of the FC converter 24, the process of fixing the inverter terminal voltage Vinv by the BAT converter 34 is cancelled. From the time point t25, the BAT converter 34 is returned to the voltage step-up state.

At the time point t25, when the FC voltage Vfc becomes the open circuit voltage VfcOCV, since voltage step-up operation of the FC converter 24 is disabled, the FC converter 24 is placed in the interruption state. Therefore, the switching element S11 is switched to the OFF state.

At the time point t28, the battery charging limit electrical power Pbatclmt becomes lower than the threshold voltage Pbatth, and it is determined that the charging margin of the battery 30 becomes sufficient. Then, the power generation interruption request flag Fcutreq is switched from the ON state to the OFF state. At the time point t28, the interruption state of the FC converter 24 is cancelled, and the FC converter 24 is placed in the voltage step-up state.

In the time chart in FIG. 8, a comparative example which is not subjected to any countermeasure is shown by broken lines in the period from the time point t24 to the time point t26. In the comparative example, since the process of fixing the inverter terminal voltage Vinv during the period from the time point t24 to the time point t26 is not performed, the target FC voltage Vfctar cannot be controlled appropriately. In the comparative example, after the time point t24, the battery electrical power Pbat may exceed the battery charging limit electrical power Pbatclmt undesirably.

### Summary of the Second Embodiment Example

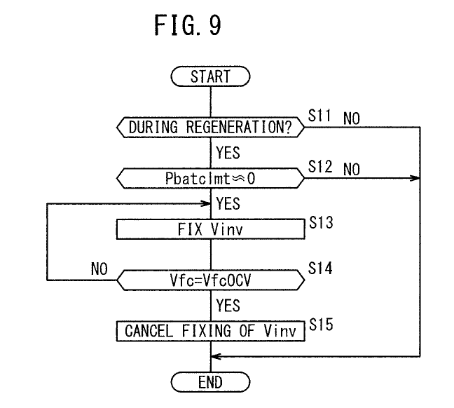

The second embodiment example will be explained also with reference to the flow chart shown in FIG. 9.

The FC automobile 10 for carrying out the control method of the FC automobile 10 according to the above second embodiment example includes the FC 20 for generating the FC voltage Vfc as the primary voltage, the battery 30 for producing the battery voltage Vbat as the other primary voltage, the inverter 14 for driving the motor 12, the BAT converter 34 provided between the battery 30 and the inverter 14, and configured to perform voltage conversion, and the FC converter 24 provided between the FC 20 and the inverter 14, and configured to perform voltage conversion.

As described above with reference to FIG. 8, in the control method according to the second embodiment example, in a secondary-voltage setting step from the time point t20 to the time point t23, the inverter terminal voltage Vinv as the secondary voltage is set by the FC converter 24 and/or the BAT converter 34 in correspondence with the motor required electrical power Pmreq.

Further, the control method according to the second embodiment example includes a secondary-voltage temporarily-fixing step (from the time point t24 to the time point t26, step S13). In this step, during regeneration from the time point t23 to the time point t25 (step S11: YES), at the time point t24 when the margin of the battery charging limit electrical power Pbatclmt gets closer to zero (Pbatclmt≈0, step S12: YES), the inverter terminal voltage Vinv is temporarily fixed by the BAT converter 34 when the inverter terminal voltage Vinv decreases based on decrease in the motor required electrical power Pmreq and/or the regenerative electrical power of the motor 12 (Generation of the regenerative electrical power starts at the time point t23, and ends at the time point t26).

As described above, by temporarily fixing the inverter terminal voltage Vinv, which is the secondary voltage, during the period from the time point t24 to the time point t25, in step S14, since control can be implemented in a manner that the FC voltage Vfc is increased linearly by the FC converter 24 so as to become the FC open circuit voltage VfcOCV, it is possible to reduce the risk that the FC electrical power Pfc is drawn out of the FC 20 to deteriorate the controllability of the FC voltage Vfc. When the FC voltage Vfc becomes the FC open circuit voltage VfcOCV (step S14: YES, time point t25), in step S15, fixing of the inverter terminal voltage Vinv by the BAT converter 34 is cancelled.

In this second embodiment example, the battery charging limit electrical power Pbatclmt is used as a parameter. Alternatively, as in the case of the first embodiment example and the modified example of the first embodiment example, the method may further include the SOC detection step of detecting the SOC of the battery 30, and the secondary-voltage temporarily-fixing step may be performed when the detected SOC is a SOC threshold or more. That is, in a case where the SOC of the battery 30 is equal to or more than a SOC threshold value, charging of the battery 30 may be wasteful, or overcharging of the battery 30 may occur undesirably. In such a case, by temporarily fixing the inverter terminal voltage Vinv as the secondary voltage, it is possible to prevent overcharging of the battery 30, and degradation of the fuel economy (electric power efficiency) of the FC automobile 10 as the fuel cell system.

### Modified Example of the Second Embodiment Example

In the above first embodiment example, as described with reference to FIGS. 4 and 6, if there is a risk that the SOC may exceed the upper limit SOCuplmt due to the surplus electrical power of the FC 20 during the idling stop, control is implemented in a manner that the inverter terminal voltage Vinv increases stepwise. Also in the case where the accelerator pedal of the FC automobile 10 is in the deceleration state where the accelerator pedal is released, there is a risk of overcharging of the battery 30 due to regenerative electrical power. Thus, when it is determined that the FC automobile 10 is in the deceleration state and there is a risk of overcharging, the BAT converter 34 and/or the FC converter 24 may be controlled in a manner that the inverter terminal voltage Vinv as the common secondary voltage of the BAT converter 34 and the FC converter 24 becomes higher than the FC open circuit voltage VfcOCV.

That is, normally, the battery 30 is charged with the FC electrical power Pfc which becomes redundant (i.e., surplus power) during deceleration of the FC automobile 10. Therefore, if the FC electrical power Pfc is continuously generated (if power generation is continued), there is a risk that overcharging of the battery 30 occurs. In such a case, by increasing the inverter terminal voltage Vinv, which is the secondary voltage, to become higher than the FC open circuit voltage VfcOCV, the output from the FC 20 can be interrupted, and it is possible to prevent overcharging of the battery 30.

It should be noted that the present invention is not limited to the above embodiments. It is a matter of course that various structures can be adopted based on the disclosure of this specification.

What is claimed is:

1. A method of controlling a fuel cell system, the fuel cell system comprising:
a fuel cell configured to generate fuel cell voltage as a primary voltage;
an electrical storage device configured to generate electrical storage device voltage as another primary voltage;
a load drive unit to which a secondary voltage is supplied, the load drive unit being configured to drive a load;
a first converter provided between the electrical storage device and the load drive unit, and configured to perform voltage conversion between the electrical storage device voltage and the secondary voltage; and
a second converter provided between the fuel cell and the load drive unit, and configured to perform voltage conversion between the fuel cell voltage and the secondary voltage,
the method comprising:
a secondary-voltage stepping-up step of controlling the first converter to thereby allow the secondary voltage to become higher than the fuel cell voltage, without following a change of required electrical power for the load.

2. The method of controlling the fuel cell system according to claim 1, further comprising:
before the secondary-voltage stepping-up step, an electrical storage device charging-state determining step of determining whether or not charging of the electrical storage device with electrical power generated by the fuel cell is in an acceptable state,
wherein if it is determined that charging of the electrical storage device with the electrical power generated by the fuel cell is not in an acceptable state, the secondary-voltage stepping-up step is performed.

3. The method of controlling the fuel cell system according to claim 2, wherein in the electrical storage device charging-state determining step, a state of charge, i.e., SOC, of the electrical storage device is detected, and if the detected SOC is equal to or more than a SOC threshold value, the secondary-voltage stepping-up step is performed.

4. The method of controlling the fuel cell system according to claim 1,
wherein, before the secondary-voltage stepping-up step, the first converter is placed in a stopped state to directly connect the electrical storage device to the load drive unit.

5. The method of controlling the fuel cell system according to claim 1, further comprising:
a power generation current zero-value setting step of setting power generation current to a zero value before controlling the first converter to thereby allow the secondary voltage to become higher than the fuel cell voltage.

6. A method of controlling a fuel cell system, the fuel cell system comprising:
a fuel cell configured to generate fuel cell voltage as a primary voltage;
an electrical storage device configured to generate electrical storage device voltage as another primary voltage;
a load drive unit to which a secondary voltage is supplied, the load drive unit being configured to drive a load;
a first converter provided between the electrical storage device and the load drive unit, and configured to perform voltage conversion between the electrical storage device voltage and the secondary voltage; and
a second converter provided between the fuel cell and the load drive unit, and configured to perform voltage conversion between the fuel cell voltage and the secondary voltage,
the method comprising:
a secondary-voltage setting step of setting the secondary voltage by the first converter depending on required electrical power for the load; and
a secondary-voltage temporarily-fixing step of, when the secondary voltage decreases based on decrease in the required electrical power for the load and/or regenerative electrical power of the load, temporarily fixing the decreasing secondary voltage by the first converter.

7. The method of controlling the fuel cell system according to claim 6, further comprising a SOC detecting step of detecting a state of charge, i.e., SOC, of the electrical storage device,
wherein if the detected SOC is equal to or more than an SOC threshold value, the secondary-voltage temporarily-fixing step is performed.

8. The method of controlling the fuel cell system according to claim 6,
wherein in a case where the decrease of the secondary voltage is caused by regenerative electrical power of the load, the secondary-voltage temporarily-fixing step continues until generation of the regenerative electrical power of the load is finished.

9. A method of controlling a fuel cell automobile, the fuel cell automobile comprising:
a fuel cell configured to generate fuel cell voltage as a primary voltage;
an electrical storage device configured to generate electrical storage device voltage as another primary voltage;
a motor drive unit to which a secondary voltage is supplied, the motor drive unit being configured to drive a motor which produces driving power for allowing travel of the fuel cell automobile,
a first converter provided between the electrical storage device and the motor drive unit, and configured to perform voltage conversion between the electrical storage device voltage and the secondary voltage; and
a second converter provided between the fuel cell and the motor drive unit, and configured to perform voltage conversion between the fuel cell voltage and the secondary voltage,
the method comprising:
a deceleration determining step of determining whether or not the fuel cell automobile is in a deceleration state; and
a secondary-voltage stepping-up step of, when the fuel cell automobile is in the deceleration state, controlling the first converter to thereby allow the secondary voltage to become higher than the fuel cell voltage.

10. A fuel cell automobile comprising:
a fuel cell configured to generate fuel cell voltage as a primary voltage;
an electrical storage device configured to generate electrical storage device voltage as another primary voltage;
a motor drive unit to which a secondary voltage is supplied, the motor drive unit being configured to drive a motor which produces driving power for allowing travel of the fuel cell automobile,
a first converter provided between the electrical storage device and the motor drive unit, and configured to perform voltage conversion between the electrical storage device voltage and the secondary voltage; and
a second converter provided between the fuel cell and the motor drive unit, and configured to perform voltage conversion between the fuel cell voltage and the secondary voltage,
a deceleration state detection sensor; and
an electronic control unit connected to the fuel cell, the electrical storage device, the motor drive unit, the first converter, the second converter, and the deceleration state detection sensor,
wherein when the electronic control unit determines that the fuel cell automobile is in a deceleration state based on an output of the deceleration state detection sensor, the electronic control unit controls the first converter to thereby allow the secondary voltage to become higher than the fuel cell voltage.
